(19) United States
(12) Patent Application Publication
(10) Pub. No.: US 2026/0340529 A1
(43) Pub. Date: Oct. 29, 2026

(54) COMPREHENSION SUPPORT APPARATUS, COMPREHENSION SUPPORT METHOD, AND STORAGE MEDIUM

(71) Applicant: NEC Corporation, Tokyo (JP)

(72) Inventors: Toshihiko IMAI, Tokyo (JP); Marina ADACHI, Tokyo (JP); Shingo MORIGAKI, Tokyo (JP); Wataru TAKAYANAGI, Tokyo (JP); Kentaro MAEDA, Tokyo (JP)

(73) Assignee: NEC Corporation, Tokyo (JP)

(21) Appl. No.: 19/646,686

(22) Filed: Apr. 14, 2026

(30) Foreign Application Priority Data
Apr. 25, 2025 (JP) 2025-073166

(51) Int. Cl. G06Q 10/0631

(52) U.S. Cl. CPC G06Q 10/06311

(57) ABSTRACT

A comprehension support apparatus according to an aspect of the present disclosure includes: at least one memory storing a set of instructions; and at least one processor configured to execute the set of instructions to: receive information of a chart that is any of a figure and a table; input, into a key point generation model, the received information of a target chart that is the chart, the key point generation model being trained in such a way as to receive the information of the chart and output a key point of the chart; and output information of the key point generated by the key point generation model.

This application is based upon and claims the benefit of priority from Japanese Patent Application No. 2025-073166, filed on Apr. 25, 2025, the disclosure of which is incorporated herein in its entirety by reference.

### TECHNICAL FIELD

The present disclosure relates to a comprehension support apparatus, a comprehension support method, and a program.

### BACKGROUND ART

JP 2020-9350 A describes a task management support system that creates a time chart including a schedule line based on a start time and a required time of a task by using preceding/succeeding relationship information of the task.

### SUMMARY

An object of the present disclosure is to provide a comprehension support apparatus, a comprehension support method, and a program capable of providing information of a key point of a chart from information of the chart.

A comprehension support apparatus according to an aspect of the present disclosure includes: at least one memory storing a set of instructions; and at least one processor configured to execute the set of instructions to: receive information of a chart that is any of a figure and a table; input, into a key point generation model, the received information of a target chart that is the chart, the key point generation model being trained in such a way as to receive the information of the chart and output a key point of the chart; and output information of the key point generated by the key point generation model.

A comprehension support method according to an aspect of the present disclosure includes: receiving information of a chart that is any of a figure and a table; inputting, into a key point generation mode, the received information of a target chart that is the chart, the key point generation model being trained in such a way as to receive the information of the chart and output a key point of the chart; and outputting information of the key point generated by the key point generation model.

A non-transitory computer readable storage medium according to an aspect of the present disclosure stores a program for causing a computer to execute: input receiving processing of receiving information of a chart that is any of a figure and a table; key point specifying processing of inputting, into a key point generation model, the received information of a target chart that is the chart, the key point generation model being trained in such a way as to receive information of a chart and output a key point of the chart; and output processing of outputting information of the key point generated by the key point generation model.

### BRIEF DESCRIPTION OF THE DRAWINGS

FIG. 1 is a block diagram illustrating an example of a configuration of a comprehension support apparatus according to the present disclosure;

FIG. 2 is a flowchart illustrating an example of an operation of the comprehension support apparatus according to the present disclosure;

FIG. 3 is a block diagram illustrating an example of a configuration of a comprehension support apparatus according to the present disclosure;

FIG. 4 is a block diagram illustrating an example of a configuration of a comprehension support system according to the present disclosure;

FIG. 5 is a flowchart illustrating an example of an operation of the comprehension support apparatus according to the present disclosure;

FIG. 6 is a block diagram illustrating an example of a configuration of a comprehension support apparatus according to the present disclosure;

FIG. 7 is a flowchart illustrating an example of an operation of the comprehension support apparatus according to the present disclosure;

FIG. 8 is a block diagram illustrating an example of a configuration of a comprehension support apparatus according to the present disclosure;

FIG. 9 is a flowchart illustrating an example of an operation of the comprehension support apparatus according to the present disclosure;

FIG. 10 is a flowchart illustrating the example of the operation of the comprehension support apparatus according to the present disclosure; and

FIG. 11 is a diagram illustrating an example of a hardware configuration of a computer capable of achieving the comprehension support apparatus according to the present disclosure.

### EXAMPLE EMBODIMENT

Hereinafter, example embodiments of the present disclosure will be described in detail with reference to the drawings.

### First Example Embodiment

First, a first example embodiment of the present disclosure will be described in detail with reference to the drawings.

### Configuration

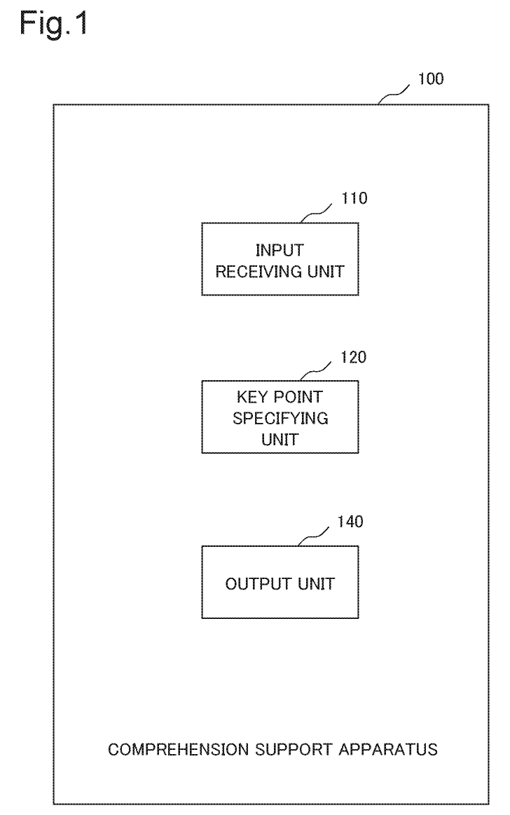

FIG. 1 is a block diagram illustrating an example of a configuration of a comprehension support apparatus according to the present disclosure.

Firstly, an example of a configuration of a comprehension support apparatus according to a first example embodiment of the present disclosure will be described in detail with reference to FIG. 1.

In the example illustrated in FIG. 1, the comprehension support apparatus 100 includes an input receiving unit 110, a key point specifying unit 120, and an output unit 140.

### Input Receiving Unit 110

The input receiving unit 110 receives information of a chart that is one of a figure and a table. The information of the chart may be, for example, image data of the chart. The information of the chart may be, for example, data of a document including the chart and information for specifying the chart. In this case, the input receiving unit 110 may generate image data of a chart specified by information for specifying the chart from data of a document.

### Key Point Specifying Unit 120

The key point specifying unit 120 inputs information of a target chart, which is the received chart, into a key point generation model trained in such a way to receive information of a chart and output a key point of the chart. The key point generation model generates a key point of an input chart from the input information of the chart, and outputs information of the generated key point. The key point specifying unit 120 receives information of the generated key point from the key point generation model. The key point generation model may be implemented in an information processing apparatus different from the comprehension support apparatus 100. The key point specifying unit 120 itself may include the key point generation model. In this case, the key point specifying unit 120 generates the key point of the input chart from the input information of the chart by using the key point generation model included in the key point specifying unit 120.

The key point of a chart represents information extracted from the chart. The key point of the chart does not need to be a sentence. Examples of the chart and the key point will be described in detail later.

The key point generation model may be trained in such a way to estimate a type of information to be extracted as a key point from the received chart, for example, by using a record of past instructions for extracting a key point from a chart, in which a chart and a type of information to be extracted as a key point from the chart are designated. The key point generation model may be further trained in such a way to extract information of the estimated type from the received chart by using training data including a chart, information extracted from the chart, and information indicating a type of the information. The key point generation model is achieved by a processor that executes a program for achieving functions of the key point generation model by using parameters determined by training.

The key point generation model may be achieved by a so-called large-scale language model. The key point generation model is not limited to a so-called large-scale language model.

### Output Unit 140

The output unit 140 outputs information of the key point generated by the key point generation model. The output unit 140 outputs the information of the key point to, for example, a display of the comprehension support apparatus 100. The output unit 140 may output the information of the key point to, for example, another information processing apparatus such as a terminal device of a user, which is communicably connected to the comprehension support apparatus 100. The output unit 140 may output the information of the key point to, for example, a storage device that is communicably connected to the comprehension support apparatus 100.

### Operation

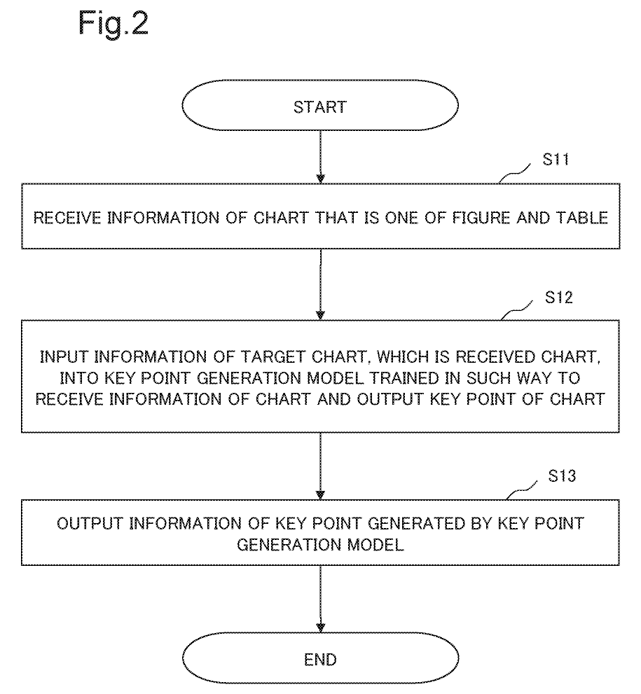

FIG. 2 is a flowchart illustrating an example of an operation of the comprehension support apparatus according to the present disclosure.

Hereinafter, an example of the operation of the comprehension support apparatus according to the first example embodiment of the present disclosure will be described in detail with reference to FIG. 2.

In the example illustrated in FIG. 2, the input receiving unit 110 receives information of a chart that is one of a figure and a table (Step S11). The key point specifying unit 120 inputs information of a target chart, which is the received chart, into a key point generation model trained in such a way to receive information of a chart and output a key point of the chart (Step S12). The output unit 140 outputs information of the key point generated by the key point generation model (Step S13).

### Effects

The present example embodiment has an effect of providing information of a key point of a chart from information of a chart.

The reason is that the input receiving unit 110 receives information of a chart that is one of a figure and a table. This is because the key point specifying unit 120 inputs information of a target chart, which is the received chart, into a key point generation model trained in such a way to receive information of a chart and output a key point of the chart. This is because the output unit 140 outputs information of the key point generated by the key point generation model. As a result, information of the key point of the chart is generated from the information of the chart, and the generated information of the key point of the chart is provided.

### Second Example Embodiment

Next, a second example embodiment of the present disclosure will be described in detail with reference to the drawings. At least a part of a configuration of the second example embodiment of the present disclosure can be applied to the first example embodiment. At least a part of each modification of the second example embodiment of the present disclosure which will be described later can be applied to each of the first example embodiment, the second example embodiment, and other example embodiments.

### Configuration

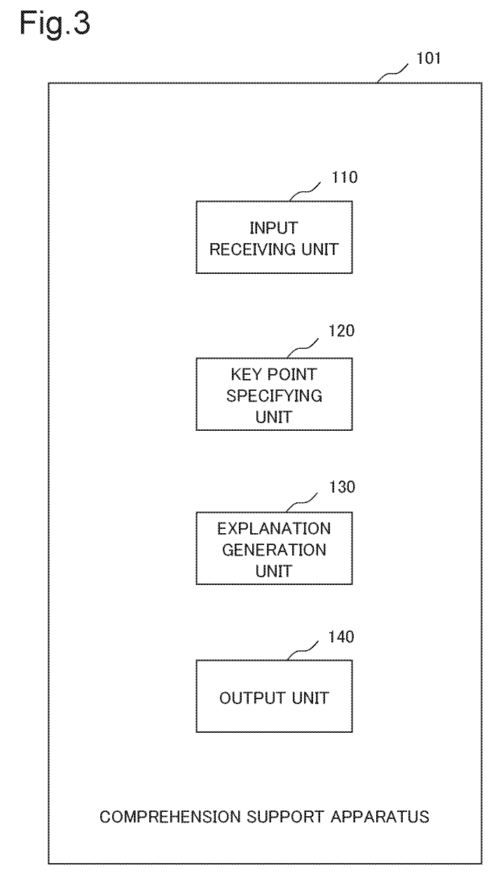

FIG. 3 is a block diagram illustrating an example of a configuration of a comprehension support apparatus according to the present disclosure.

An example of the configuration of the comprehension support apparatus according to the second example embodiment of the present disclosure will be described below in detail with reference to FIG. 3.

In the example illustrated in FIG. 3, a comprehension support apparatus 101 includes an input receiving unit 110, a key point specifying unit 120, an explanation generation unit 130, and an output unit 140. The input receiving unit 110, the key point specifying unit 120, and the output unit 140 of the present example embodiment are the same as the input receiving unit 110, the key point specifying unit 120, and the output unit 140 of the first example embodiment except for differences in the following description.

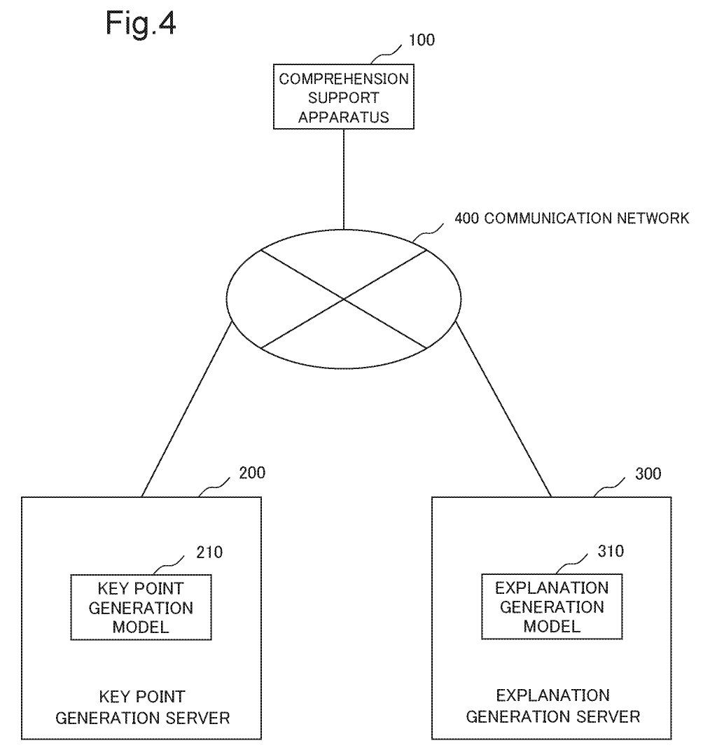

FIG. 4 is a block diagram illustrating an example of a configuration of a comprehension support system according to the present disclosure.

In the example illustrated in FIG. 4, in the comprehension support system, the comprehension support apparatus 101 is communicably connected to each of a key point generation server 200 and an explanation generation server 300 via a communication network 400.

The key point generation server 200 includes a key point generation model 210. The key point generation model 210 is the same as the key point generation model of the first example embodiment.

The explanation generation server 300 includes an explanation generation model 310. The explanation generation model 310 will be described in the description of an explanation generation unit 130 which will be described later.

### Input Receiving Unit 110

The input receiving unit 110 receives information of a chart that is one of a figure and a table, and information of an attribute of a reader of the chart.

### Key Point Specifying Unit 120

The key point specifying unit 120 specifies information of a key point of a chart from information of a target chart that is the received chart, and the information of the attribute of the reader of the chart. Specifically, the key point specifying unit 120 causes the key point generation model 210 to generate information of the key point of the chart from the information of the target chart that is the received chart, and the information of the attribute of the reader of the chart. More specifically, the key point specifying unit 120 inputs the information of the target chart that is the received chart, and the information of the attribute of the reader of the chart into the key point generation model 210 trained in such a way to receive information of the chart and information of the attribute and output the key point of the chart according to the attribute. The key point generation model 210 generates the key point of the received chart according to the received attribute. The key point generation model 210 outputs information of the generated key point. The key point specifying unit 120 receives the output information of the key point.

The key point of the chart according to the attribute is, for example, information of a key point of the chart, which is information of a key point of a type determined for the attribute of the reader. The type of the key point represents, for example, the type of information extracted from the chart. A relationship between the attribute of the reader and the type of the key point defined for the attribute may be defined in advance. Information representing the relationship between the attribute of the reader and the type of the key point defined for the attribute may be given to the key point generation model 210 in advance. The key point generation model 210 may be configured to determine a type of information to be extracted from the chart by using the received information of the attribute, extract information of the determined type from the chart, and output the extracted information as a key point of the chart. In other words, the key point generation model 210 may be configured to specify a type of information to be extracted from the chart, which is defined for the received information of the attribute, extract information of the specified type from the chart, and output the extracted information as a key point of the chart.

The key point generation model 210 may be trained in such a way to determine a type of a key point to be generated from the attribute of the reader by using training data including a record of a combination of the attribute of the reader and a type of information of which an instruction to be extracted from the chart is given from the reader. The training data may include, for example, a record of a combination of the attribute of the reader and a type of information of which an instruction to be extracted from the chart is given from the reader, in a past instruction to designate information of a type of a key point and extract the key point. The key point generation model 210 may be configured to determine a type of information to be extracted from the chart by using the received information of the attribute, extract information of the determined type from the chart, and output the extracted information as a key point of the chart. In other words, the key point generation model 210 may be configured to specify a type of information to be extracted from the chart, which is combined with the attribute whose information has been received, extract information of the specified type from the chart, and output the extracted information as a key point of the chart.

The input receiving unit 110 may further receive information representing the type of the key point extracted from the chart. In a case where the information representing the type of the key point to be extracted from the chart has been received, the key point specifying unit 120 may further input the information representing the type of the key point to be extracted from the chart into the key point generation model 210. When further receiving the information representing the type of the key point to be extracted from the chart, the key point generation model 210 may be configured to extract information of the type of the key point indicated by the received information from the chart and output the extracted information as the key point of the chart.

### Explanation Generation Unit 130

The explanation generation unit 130 generates an explanatory sentence of the key point generated by the key point generation model. Specifically, the explanation generation unit 130 causes the explanation generation model 310 to generate an explanatory sentence of the key point generated by the key point generation model. More specifically, the explanation generation unit 130 inputs an instruction to generate an explanatory sentence of the key point generated by the key point generation model to the explanation generation model 310 that generates an explanatory sentence in accordance with the instruction. The explanation generation model 310 generates an explanatory sentence of the key point generated by the key point generation model in accordance with the received instruction. The explanation generation model 310 outputs information of the generated explanatory sentence of the key point. The explanatory sentence of the key point is a sentence for explaining information of the key point. It can be said that the explanatory sentence of the key point is a form of the information of the key point. The explanation generation unit 130 receives information of the explanatory sentence of the key point from the explanation generation model.

The explanation generation model 310 may be achieved by, for example, a so-called large-scale language model. The explanation generation model 310 may be achieved by a model that is not a large-scale language model.

In the example illustrated in FIG. 3, the explanation generation model 310 is implemented as a model different from the above-described key point generation model 210. The explanation generation model 310 may be implemented as the same model as the key point generation model 210 described above. In other words, the key point generation model 210 may operate as the explanation generation model 310. The key point generation model 210 and the explanation generation model 310 may be implemented in the comprehension support apparatus 101 instead of a server (the key point generation server 200 and the explanation generation server 300) different from the comprehension support apparatus 101.

### Output Unit 140

The output unit 140 outputs the explanatory sentence generated by the explanation generation model, as information of the key point of the chart. An output destination of the explanatory sentence of the output unit 140 in the present example embodiment is similar to an output destination to which the output unit 140 in the first example embodiment outputs the information of the key point.

### Example of Chart and Key Point

Examples of a chart and a key point will be described below. The chart and the key point are not limited to the examples which will be described below.

The chart is, for example, a line chart indicating schedules of work of a plurality of persons working together. In this line chart, time when the work is performed and the next work using the result of the work are specified.

For example, in a case where the attribute of the reader is a manager, the key point is information of work whose influence on a schedule of the work of another person satisfies a criterion among pieces of works of a plurality of persons and information of the person who performs the work. The work whose influence on a schedule of work (referred to as another work below) of another person satisfies a criterion is, for example, work in which a difference between a scheduled timing at which this work ends and a scheduled timing at which another work using a result of this work starts is equal to or less than a predetermined length. In this case, in a case where the magnitude (the length of time) of delay of work is longer than a length from a timing when the work is scheduled to end to the earliest timing among timings when another work using the result of the work is scheduled to start, the delay of work affects the start of another work using the result of the work. The work whose influence on a schedule of work (referred to as another work below) of another person satisfies the criterion may be, for example, work in which the number of persons who execute other work using the result of the work is equal to or more than a predetermined number.

For example, in a case where the attribute of the reader is information indicating any one of a plurality of persons, the key point may be information of work whose influence on the schedule of the work of another person satisfies the criterion among pieces of work of the person indicated by the attribute. In this case, the key point may include information of the schedule of work of the person indicated by the attribute.

The chart may represent, for example, contents and schedules of work of a plurality of persons having different roles in a procedure performed by the plurality of persons having different roles. The schedule is, for example, information of a timing to perform work. The information of the timing to perform the work is, for example, information of a day or date and time when the work is designated to be performed. The information of the timing to perform the work may be, for example, information of a period during which the work is performed. The period during which the work is performed may be a period during which the work is continuously performed. The period during which the work is performed may be a period in which a day or a date and time on which the work is performed is selected.

In this case, the schedule represented by the chart may be represented by the date and time elapsed from the date and time of the start of the procedure. The input receiving unit 110 may further receive information of a specific date and time of the start of the procedure.

In this case, the attribute of the reader is information for specifying a target role that is a role of one person among roles of a plurality of persons. The key point is information of a content and a schedule of work of the person having the target role. The explanatory sentence of the key point in this case is a sentence explaining the content and schedule of the work.

In a case where the input receiving unit 110 does not receive the information of a specific date and time of the start of the procedure, the key point specifying unit 120 causes the key point generation model to generate information of a key point including information of a date and time elapsed from the date and time of the start of the procedure, as the information representing the schedule. In this case, in the explanatory sentence of the key point, the schedule is described by using the date and time elapsed from the date and time of the start of the procedure.

In a case where the input receiving unit 110 receives the information of the specific date and time of the start of the procedure, the key point specifying unit 120 causes the key point generation model to generate information of the key point including the information of the specific date and time, as the information representing the schedule. In this case, in the explanatory sentence of the key point, the schedule is described by using the specific date and time. In this case, for example, the input receiving unit 110 may further receive information for identifying a user who inputs the chart. The output unit 140 may transmit the information of the schedule represented by the information of the key point to a schedule server that manages the schedule, as the information of the schedule of the user indicated by the information for identifying the user. In a case where the schedule server has received the information of the schedule of the user, the schedule server may add the received information of the schedule to information of the schedule of the user, which is managed by the schedule server.

### Operation

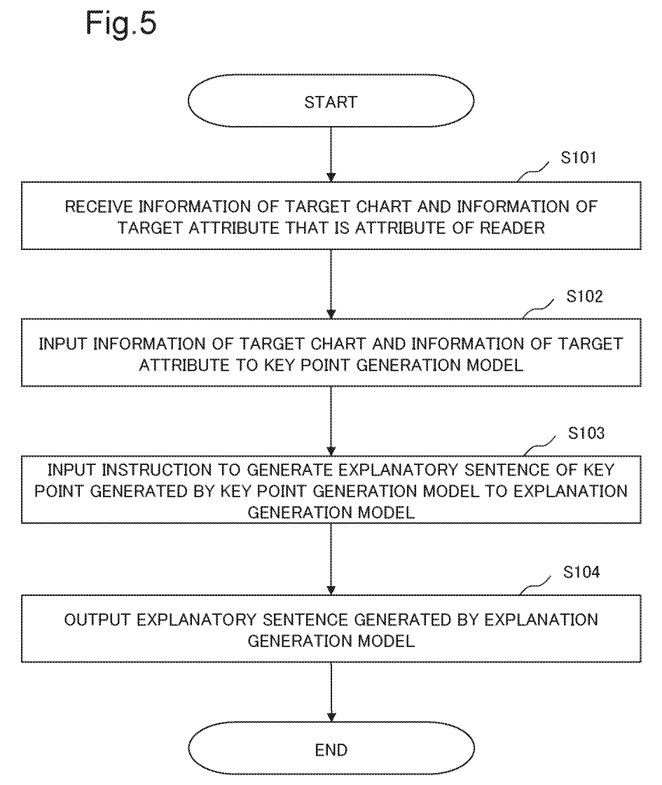

FIG. 5 is a flowchart illustrating an example of an operation of the comprehension support apparatus according to the present disclosure. An example of the operation of the comprehension support apparatus according to the present example embodiment will be described below in detail with reference to FIG. 5.

In the example illustrated in FIG. 5, the input receiving unit 110 receives information of a target chart and information of a target attribute that is an attribute of the reader (Step S101). The key point specifying unit 120 inputs the information of the target chart and the information of the target attribute to the key point generation model (Step S102). The explanation generation unit 130 inputs an instruction to generate an explanatory sentence of the key point generated by the key point generation model to the explanation generation model (Step S103). The output unit 140 outputs the explanatory sentence generated by the explanation generation model (Step S104).

### Effects

The present example embodiment has the effect same as that of the first example embodiment. The effect is achieved for the same reason that the effect of the first example embodiment is achieved.

### First Modification of Second Example Embodiment

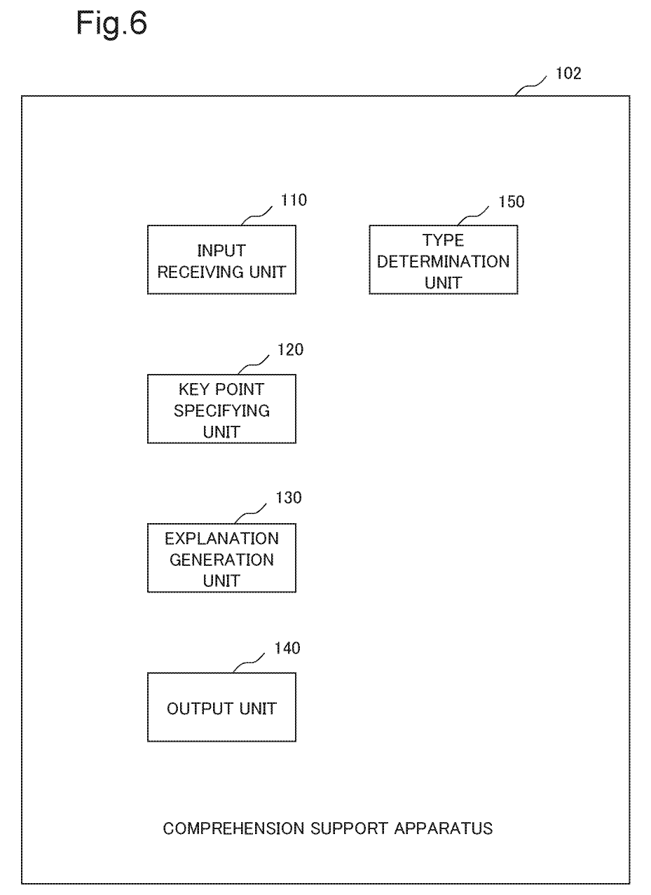

FIG. 6 is a block diagram illustrating an example of a configuration of a comprehension support apparatus according to the present disclosure.

In the example illustrated in FIG. 6, a comprehension support apparatus 102 includes an input receiving unit 110, a key point specifying unit 120, an explanation generation unit 130, an output unit 140, and a type determination unit 150. The input receiving unit 110, the key point specifying unit 120, the explanation generation unit 130, and the output unit 140 of the present modification are the same as the input receiving unit 110, the key point specifying unit 120, the explanation generation unit 130, and the output unit 140 of the second example embodiment except for differences in the following description.

### Type Determination Unit 150

The type determination unit 150 estimates the type of target chart that is the received chart. The type of the target chart represents, for example, any one of the chart described above and the chart described in the examples of the key point.

The type determination unit 150 may estimate the type of the target chart by using, for example, a type determination model trained in such a way to estimate the type of chart from information of the chart by using training data including a combination of information of the chart and the information of the type of the chart.

### Key Point Specifying Unit 120

The key point specifying unit 120 inputs the information of the target chart, the information of the type of the target chart, and the information of the target attribute that is the attribute of the reader, into the key point generation model 210.

The key point generation model 210 is trained in such a way to receive the information of a chart, information of the type of the chart, and information of an attribute, and output a key point of the chart according to the attribute and the type of the chart.

Information of a combination of the information of the type of chart, the information of the attribute, and information of a type of key point, which are associated with each other, may be given to the key point generation model 210 in advance. The key point generation model 210 may specify information of the type of a key point associated with the information of the type of the chart and the information of the attribute, which have been received, by using the information of the combination. The key point generation model 210 generates information of the specified type of the key point and outputs the generated information of the key point.

The key point generation model 210 may be trained in such a way to determine the type of a key point from the type of a chart and an attribute of a reader by using an instruction to generate information of a key point from the information of the chart and the type of the chart (the instruction having been given by designating the type of key point) and a record of a combination with an attribute of the reader who has performed this instruction, and to generate information of the key point of the determined type from the information of the chart. The key point generation model 210 determines the type of the key point from the information of the type of the chart and the information of the attribute, which have been received, generates the information of the key point of the determined type from the information of the chart, and outputs the generated information of the key point.

### Operation

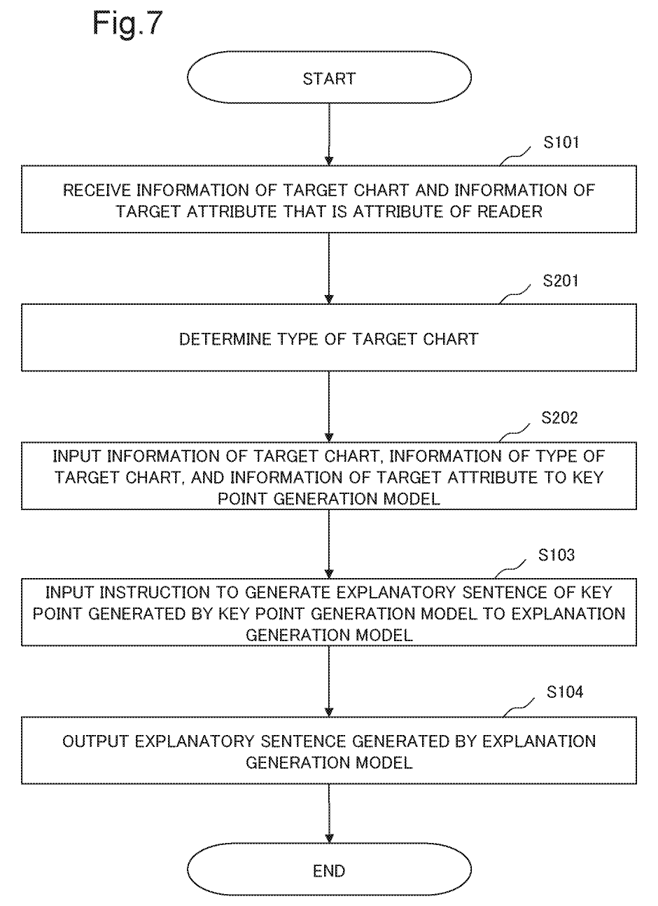

FIG. 7 is a flowchart illustrating an example of an operation of the comprehension support apparatus according to the present disclosure. An example of the operation of the comprehension support apparatus according to the present modification will be described below in detail with reference to FIG. 7.

In the example illustrated in FIG. 7, the input receiving unit 110 receives information of a target chart and information of a target attribute that is an attribute of the reader (Step S101). The type determination unit 150 determines the type of the target chart (Step S201). The key point specifying unit 120 inputs the information of the target chart, the information of the type of the target chart, and the information of the target attribute to the key point generation model (Step S202). The explanation generation unit 130 inputs an instruction to generate an explanatory sentence of the key point generated by the key point generation model to the explanation generation model (Step S103). The output unit 140 outputs the explanatory sentence generated by the explanation generation model (Step S104).

### Second Modification of Second Example Embodiment

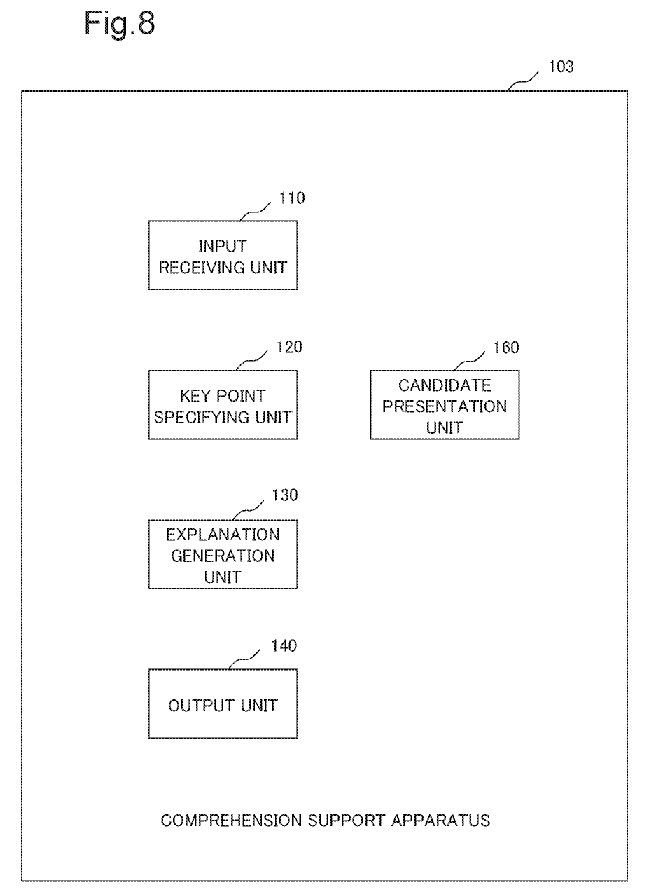

FIG. 8 is a block diagram illustrating an example of a configuration of a comprehension support apparatus according to the present disclosure.

In the example illustrated in FIG. 8, a comprehension support apparatus 103 includes an input receiving unit 110, a key point specifying unit 120, an explanation generation unit 130, an output unit 140, and a candidate presentation unit 160. The input receiving unit 110, the key point specifying unit 120, the explanation generation unit 130, and the output unit 140 of the present modification are the same as the input receiving unit 110, the key point specifying unit 120, the explanation generation unit 130, and the output unit 140 of the second example embodiment except for differences in the following description.

### Candidate Presentation Unit 160

In a case where a plurality of key points are output by the key point generation model, the candidate presentation unit 160 presents information of the plurality of key points. For example, the candidate presentation unit 160 outputs information of a plurality of key points to a device that has input the information of the chart to the input receiving unit 110.

The candidate presentation unit 160 may present, for example, information of a word/phrase having a predetermined number or less of characters representing the key point, as the presented key point information that is information of the key point presented by the candidate presentation unit 160. When receiving the information of the key point, the candidate presentation unit 160 may generate the presented key point information by using a word/phrase model configured to generate a word/phrase having a predetermined number or less of characters representing the key point and output the generated word/phrase. Specifically, the candidate presentation unit 160 inputs information of the key point and an instruction to generate a word/phrase having a predetermined number or less of characters representing the key point to the word/phrase model. When receiving the information of the key point, the word/phrase model generates a word/phrase having a predetermined number or less of characters representing the key point, and outputs the generated word/phrase. The candidate presentation unit 160 receives the generated word/phrase from the word/phrase model. The candidate presentation unit 160 presents information representing the received word/phrase as presented key point information. The word/phrase model may be achieved by, for example, a so-called large-scale language model. For example, the explanation generation model 310 may operate as the word/phrase model.

### Input Receiving Unit 110

In a case where a plurality of key points are output by the key point generation model, information of a selected key point that is a key point selected from the plurality of key points is received. Specifically, the input receiving unit 110 receives, for example, information indicating the presented key point information selected from pieces of the presented key point information of all the plurality of key points, from the device to which the pieces of presented key point information of all the plurality of key points are presented.

### Explanation Generation Unit 130

In a case where a plurality of key points are output by the key point generation model, the explanation generation unit 130 generates an explanatory sentence of a selected key point selected from the plurality of key points. Specifically, the explanation generation unit 130 causes the explanation generation model 310 to generate an explanatory sentence of the selected key point. A method by which the explanation generation unit 130 causes the explanation generation model 310 to generate the explanatory sentence of the selected key point is the same as the above-described method by which the explanation generation unit 130 causes the explanation generation model 310 to generate the explanatory sentence of the key point.

### Output Unit 140

The output unit 140 outputs information of the selected key point. Specifically, the output unit 140 outputs information of the explanatory sentence of the selected key point generated by the explanation generation model 310.

### Operation

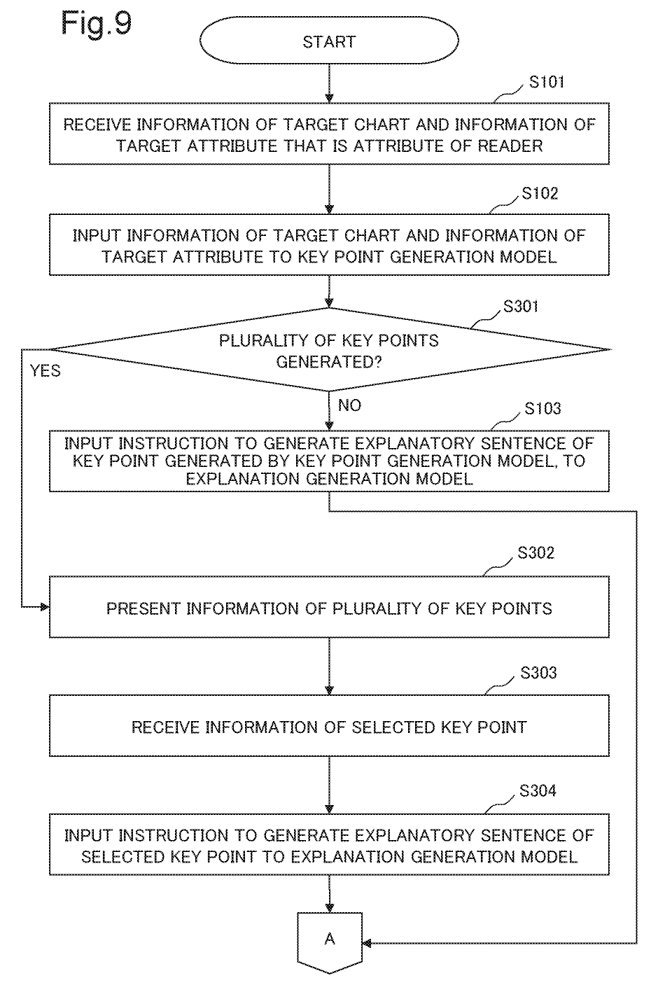

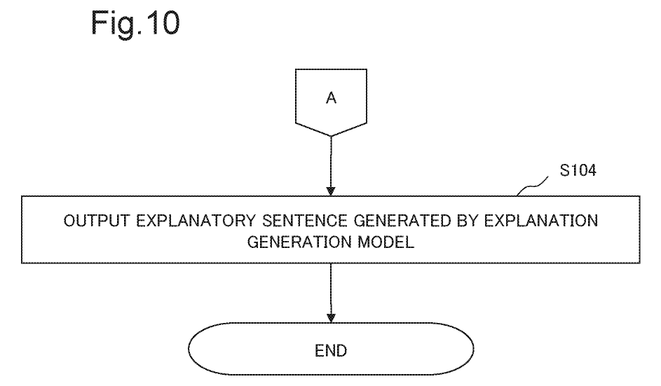

FIGS. 9 and 10 are flowcharts illustrating the example of the operation of the comprehension support apparatus according to the present disclosure.

An example of the operation of the comprehension support apparatus according to the present modification will be described below in detail with reference to FIGS. 9 and 10.

In the example illustrated in FIG. 9, the input receiving unit 110 receives information of a target chart and information of a target attribute that is an attribute of the reader (Step S101). The key point specifying unit 120 inputs the information of the target chart and the information of the target attribute to the key point generation model (Step S102).

In a case where a plurality of key points are not generated (NO in Step S301), the explanation generation unit 130 inputs an instruction to generate an explanatory sentence of the key point generated by the key point generation model, to the explanation generation model (Step S103). Then, the comprehension support apparatus 103 performs the operation illustrated in FIG. 10.

In a case where a plurality of key points are generated (YES in Step S301), the candidate presentation unit 160 presents information of the plurality of key points (Step S302). Then, the input receiving unit 110 receives information of a selected key point (Step S303). Then, the explanation generation unit 130 inputs an instruction to generate an explanatory sentence of the selected key point to the explanation generation model (Step S304). Then, the comprehension support apparatus 103 performs the operation illustrated in FIG. 10.

In the example illustrated in FIG. 10, the output unit 140 outputs the explanatory sentence generated by the explanation generation model (Step S104).

### Other Example Embodiments

The comprehension support apparatus according to the present disclosure (in other words, the comprehension support apparatus according to any of the example embodiments and modifications of the present disclosure) can be achieved by a computer including a memory loaded with a program read from a storage medium and a processor executing the program. The comprehension support apparatus according to the present disclosure can also be achieved by dedicated hardware. The comprehension support apparatus according to the present disclosure can also be achieved by a combination of the above-described computer and dedicated hardware.

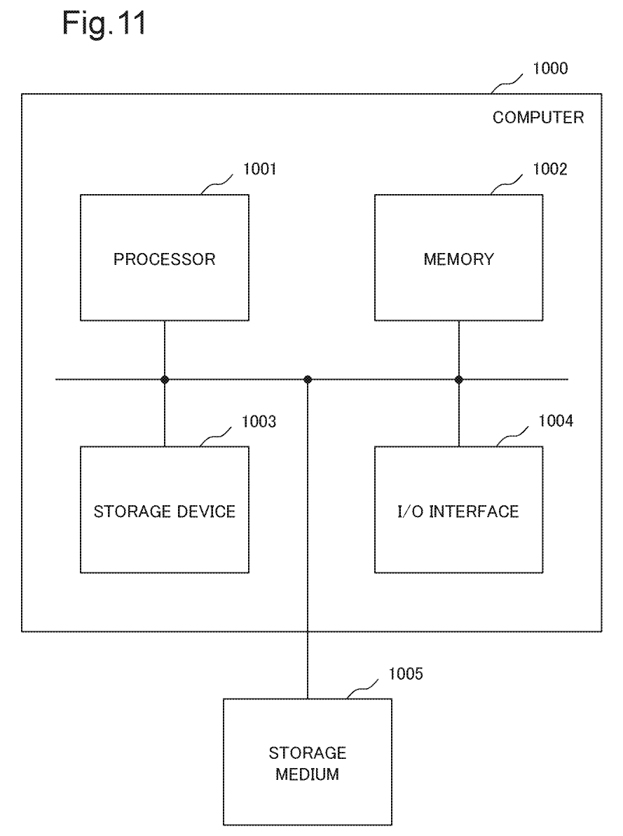

FIG. 11 is a diagram illustrating an example of a hardware configuration of a computer 1000 capable of achieving the comprehension support apparatus according to the present disclosure. FIG. 11 illustrates the example in which the computer 1000 includes a processor 1001, a memory 1002, a storage device 1003, and an input/output (I/O) interface 1004. The computer 1000 can access a storage medium 1005. The memory 1002 and the storage device 1003 are storage devices such as a random access memory (RAM) and a hard disk, for example. Examples of the storage medium 1005 include a RAM, a storage device such as a hard disk, a read only memory (ROM), and a portable storage medium. The storage device 1003 may be the storage medium 1005. The processor 1001 can read and write data and programs from and in the memory 1002 and the storage device 1003. The processor 1001 can access, for example, other devices via the I/O interface 1004. The processor 1001 can access the storage medium 1005. The storage medium 1005 stores a program for causing the computer 1000 to operate as the comprehension support apparatus according to the present disclosure.

The processor 1001 loads a program stored in the storage medium 1005 into the memory 1002, the program causing the computer 1000 to operate as the comprehension support apparatus according to the present disclosure. The processor 1001 executes the program loaded in the memory 1002 to cause the computer 1000 to operate as the comprehension support apparatus according to the present disclosure.

The input receiving unit 110, the key point specifying unit 120, the explanation generation unit 130, the output unit 140, the type determination unit 150, and the candidate presentation unit 160 can be realized by, for example, the processor 1001 that executes the program loaded in the memory 1002. A part or all of the input receiving unit 110, the key point specifying unit 120, the explanation generation unit 130, the output unit 140, the type determination unit 150, and the candidate presentation unit 160 can be achieved by dedicated circuits that achieve the functions.

When a reader of a chart that is either a figure or a table contained in a sentence is not accustomed to the chart, the reader does not know what should be read from the chart in some cases.

JP 2020-9350 A describes specifying a critical path by using a predicted result line in the time chart. The task management support system in JP 2020-9350 A can specify the critical path from the information generated from the time chart. However, with the technique of JP 2020-9350 A, it is not possible to obtain information of key points of the chart from the input chart.

The present disclosure has an effect of providing information of a key point of a chart from information of a chart.

Some or all of the above example embodiments may be described as the following Supplementary Notes, but are not limited to the following.

### Supplementary Note 1

A comprehension support apparatus including:
input receiving means for receiving information of a chart that is one of a figure and a table;
key point specifying means for inputting the received information of a target chart that is the chart, into a key point generation model trained in such a way as to receive information of a chart and output a key point of the chart; and
output means for outputting information of the key point, which is generated by the key point generation model.

### Supplementary Note 2

The comprehension support apparatus according to Supplementary Note 1, in which
the input receiving means further receives information of an attribute of a reader of the chart,
the key point generation model is trained in such a way to receive the information of the chart and the information of the attribute of the reader and output the key point of the chart according to the attribute, and
the key point specifying means inputs the information of the target chart and information of a target attribute that is the attribute of the reader, to the key point generation model.

### Supplementary Note 3

The comprehension support apparatus according to Supplementary Note 2, further including:
type determination means for estimating a type of the target chart, in which
the key point generation model is trained in such a way to receive the information of the chart, information of a type of the chart, and the information of the attribute and output the key point of the chart according to the attribute and the type, and
the key point specifying means inputs the information of the target chart, information of the type of the target chart, and information of a target attribute that is the attribute of the reader, to the key point generation model.

### Supplementary Note 4

The comprehension support apparatus according to Supplementary Note 1 or 2, further including:
type determination means for estimating a type of the target chart, in which
the key point generation model is trained in such a way to receive the information of the chart and information of a type of the chart and to output the key point of the chart according to the type, and
the key point specifying means inputs the information of the target chart and information of the type of the target chart to the key point generation model.

### Supplementary Note 5

The comprehension support apparatus according to Supplementary Note 1 or 2, in which
the input receiving means receives information of a viewpoint of generating the key point,
the key point generation model is trained in such a way to further receive the information of the viewpoint and generate information of the key point according to the viewpoint, and
the key point specifying means further inputs the received information of the viewpoint to the key point generation model.

### Supplementary Note 6

The comprehension support apparatus according to Supplementary Note 1 or 2, further including:
candidate presentation means for presenting information of a plurality of key points in a case where the plurality of key points are output by the key point generation model, in which
the input receiving means receives information of a selected key point that is a key point selected from the plurality of key points, and
the output means outputs the information of the selected key point.

### Supplementary Note 7

The comprehension support apparatus according to Supplementary Note 1 or 2, in which
the chart is a line chart indicating schedules of work of a plurality of persons working together, and
the key point is information of work whose influence on a schedule of work of another person among pieces of work of the plurality of persons satisfies a criterion and information of a person who performs the work.

### Supplementary Note 8

The comprehension support apparatus according to Supplementary Note 2 or 3, in which
the chart represents contents and schedules of work of a plurality of persons in different roles,
the attribute is information for specifying a target role that is a role of one person among roles of the plurality of persons, and
the key point is information of the contents and the schedules of the work of the person of the target role.

### Supplementary Note 9

A comprehension support method including:
receiving information of a chart that is one of a figure and a table;
inputting the received information of a target chart that is the chart, into a key point generation model trained in such a way as to receive information of a chart and output a key point of the chart; and
outputting information of the key point, which is generated by the key point generation model.

### Supplementary Note 10

The comprehension support method according to Supplementary Note 9, further including:
receiving information of an attribute of a reader of the chart, in which
the key point generation model is trained in such a way to receive the information of the chart and the information of the attribute of the reader and output the key point of the chart according to the attribute, and
the comprehension support method further includes
inputting the information of the target chart and information of a target attribute that is the attribute of the reader, to the key point generation model.

### Supplementary Note 11

The comprehension support method according to Supplementary Note 10, further including:
estimating a type of the target chart, in which
the key point generation model is trained in such a way to receive the information of the chart, information of a type of the chart, and the information of the attribute and output the key point of the chart according to the attribute and the type, and
the comprehension support method further includes
inputting the information of the target chart, information of the type of the target chart, and information of a target attribute that is the attribute of the reader, to the key point generation model.

### Supplementary Note 12

The comprehension support method according to Supplementary Note 9 or 10, further including:
estimating a type of the target chart, in which
the key point generation model is trained in such a way to receive the information of the chart and information of a type of the chart and to output the key point of the chart according to the type, and
the comprehension support method further includes
inputting the information of the target chart and information of the type of the target chart to the key point generation model.

### Supplementary Note 13

The comprehension support method according to Supplementary Note 9 or 10, further including:
receiving information of a viewpoint of generating the key point, in which
the key point generation model is trained in such a way to further receive the information of the viewpoint and generate information of the key point according to the viewpoint, and
the comprehension support method further includes
further inputting the received information of the viewpoint to the key point generation model.

### Supplementary Note 14

The comprehension support method according to Supplementary Note 9 or 10, further including:
presenting information of a plurality of key points in a case where the plurality of key points are output by the key point generation model;
receiving information of a selected key point that is a key point selected from the plurality of key points; and
outputting the information of the selected key point.

### Supplementary Note 15

The comprehension support method according to Supplementary Note 9 or 10, in which
the chart is a line chart indicating schedules of work of a plurality of persons working together, and
the key point is information of work whose influence on a schedule of work of another person among pieces of work of the plurality of persons satisfies a criterion and information of a person who performs the work.

### Supplementary Note 16

The comprehension support method according to Supplementary Note 10 or 11, in which
the chart represents contents and schedules of work of a plurality of persons in different roles,
the attribute is information for specifying a target role that is a role of one person among roles of the plurality of persons, and
the key point is information of the contents and the schedules of the work of the person of the target role.

### Supplementary Note 17

A program for causing a computer to execute:
an input receiving process of receiving information of a chart that is one of a figure and a table;
a key point specifying process of inputting the received information of a target chart that is the chart, into a key point generation model trained in such a way as to receive information of a chart and output a key point of the chart; and
an output process of outputting information of the key point, which is generated by the key point generation model.

### Supplementary Note 18

The program according to Supplementary Note 17, in which
the input receiving process further includes receiving information of an attribute of a reader of the chart,
the key point generation model is trained in such a way to receive the information of the chart and the information of the attribute of the reader and output the key point of the chart according to the attribute, and
the key point specifying process includes inputting the information of the target chart and information of a target attribute that is the attribute of the reader, to the key point generation model.

### Supplementary Note 19

The program according to Supplementary Note 18, the program for causing a computer to further execute:
a type determination process of estimating a type of the target chart, in which
the key point generation model is trained in such a way to receive the information of the chart, information of a type of the chart, and the information of the attribute and output the key point of the chart according to the attribute and the type, and
the key point specifying process includes inputting the information of the target chart, information of the type of the target chart, and information of a target attribute that is the attribute of the reader, to the key point generation model.

### Supplementary Note 20

The program according to Supplementary Note 17 or 18, the program for causing a computer to further execute:
a type determination process of estimating a type of the target chart, in which
the key point generation model is trained in such a way to receive the information of the chart and information of a type of the chart and to output the key point of the chart according to the type, and
the key point specifying process includes inputting the information of the target chart and information of the type of the target chart to the key point generation model.

### Supplementary Note 21

The program according to Supplementary Note 17 or 18, in which
the input receiving process includes receiving information of a viewpoint of generating the key point,
the key point generation model is trained in such a way to further receive the information of the viewpoint and generate information of the key point according to the viewpoint, and
the key point specifying process includes further inputting the received information of the viewpoint to the key point generation model.

### Supplementary Note 22

The program according to Supplementary Note 17 or 18, the program for causing a computer to further execute:
a candidate presentation process of presenting information of a plurality of key points in a case where the plurality of key points are output by the key point generation model, in which
the input receiving process includes receiving information of a selected key point that is a key point selected from the plurality of key points, and
the output process includes outputting the information of the selected key point.

### Supplementary Note 23

The program according to Supplementary Note 17 or 18, in which
the chart is a line chart indicating schedules of work of a plurality of persons working together, and
the key point is information of work whose influence on a schedule of work of another person among pieces of work of the plurality of persons satisfies a criterion and information of a person who performs the work.

### Supplementary Note 24

The program according to Supplementary Note 18 or 19, in which
the chart represents contents and schedules of work of a plurality of persons in different roles,
the attribute is information for specifying a target role that is a role of one person among roles of the plurality of persons, and
the key point is information of the contents and the schedules of the work of the person of the target role.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

1. A comprehension support apparatus comprising:
at least one memory storing a set of instructions; and
at least one processor configured to execute the set of instructions to:
receive information of a chart that is any of a figure and a table;
input, into a key point generation model, the received information of a target chart that is the chart, the key point generation model being trained in such a way as to receive the information of the chart and output a key point of the chart; and
output information of the key point generated by the key point generation model.

2. The comprehension support apparatus according to claim 1, wherein
the at least one processor is further configured to execute the set of instructions to receive information of an attribute of a reader of the chart,
the key point generation model is trained in such a way to receive the information of the chart and the information of the attribute of the reader and to output the key point of the chart depending on the attribute, and
the at least one processor is further configured to execute the set of instructions to inputs input, to the key point generation model, the information of the target chart and information of a target attribute that is the attribute of the reader.

3. The comprehension support apparatus according to claim 2, wherein
the at least one processor is further configured to execute the set of instructions to estimate a type of the target chart,
the key point generation model is trained in such a way to receive the information of the chart, information of a type of the chart, and the information of the attribute and to output the key point of the chart according to the attribute and the type, and
the at least one processor is further configured to execute the set of instructions to input, to the key point generation model, the information of the target chart, information of the type of the target chart, and information of a target attribute that is the attribute of the reader.

4. The comprehension support apparatus according to claim 1, wherein
the at least one processor is further configured to execute the set of instructions to estimate a type of the target chart,
the key point generation model is trained in such a way to receive the information of the chart and information of the type of the chart and to output the key point of the chart depending on the type, and
the at least one processor is further configured to execute the set of instructions to input the information of the target chart and information of the type of the target chart to the key point generation model.

5. The comprehension support apparatus according to claim 1, wherein
the at least one processor is further configured to execute the set of instructions to receive information of a viewpoint of generating the key point,
the key point generation model is trained in such a way to further receive the information of the viewpoint and to generate information of the key point depending on the viewpoint, and
the at least one processor is further configured to execute the set of instructions to input the received information of the viewpoint to the key point generation model.

6. The comprehension support apparatus according to claim 1, wherein
the at least one processor is further configured to execute the set of instructions to:
present information of a plurality of key points in a case where the plurality of key points are output by the key point generation model;
receive information of a selected key point that is the key point selected from the plurality of key points; and
output the information of the selected key point.

7. The comprehension support apparatus according to claim 1, wherein
the chart is a line chart indicating schedules of work of a plurality of persons working together, and
the key point is information of work whose influence on a schedule of work of another person among pieces of work of the plurality of persons satisfies a criterion, and information of a person who performs the work.

8. The comprehension support apparatus according to claim 2, wherein
the chart represents contents and schedules of work of a plurality of persons in different roles,
the attribute is information for specifying a target role that is a role of one person among the roles of the plurality of persons, and
the key point is information of the contents and the schedules of the work of the person of the target role.

9. A comprehension support method comprising:
receiving information of a chart that is any of a figure and a table;
inputting, into a key point generation mode, the received information of a target chart that is the chart, the key point generation model being trained in such a way as to receive the information of the chart and output a key point of the chart; and
outputting information of the key point generated by the key point generation model.

10. The comprehension support method according to claim 9, further comprising
receiving information of an attribute of a reader of the chart, wherein
the key point generation model is trained in such a way to receive the information of the chart and the information of the attribute of the reader and to output the key point of the chart depending on the attribute, and
the comprehension support method further comprises inputting, to the key point generation model, the information of the target chart and information of a target attribute that is the attribute of the reader.

11. The comprehension support method according to claim 10, further comprising
estimating a type of the target chart, wherein
the key point generation model is trained in such a way to receive the information of the chart, information of a type of the chart, and the information of the attribute and to output the key point of the chart according to the attribute and the type, and
the comprehension support method further comprises inputting, to the key point generation model, the information of the target chart, information of the type of the target chart, and information of a target attribute that is the attribute of the reader.

12. The comprehension support method according to claim 9, further comprising
estimating a type of the target chart, wherein
the key point generation model is trained in such a way to receive the information of the chart and information of the type of the chart and to output the key point of the chart depending on the type, and
the comprehension support method further comprises inputting the information of the target chart and information of the type of the target chart to the key point generation model.

13. The comprehension support method according to claim 9, further comprising
receiving information of a viewpoint of generating the key point, wherein
the key point generation model is trained in such a way to further receive the information of the viewpoint and to generate information of the key point depending on the viewpoint, and
the comprehension support method further comprises inputting the received information of the viewpoint to the key point generation model.

14. The comprehension support method according to claim 9, further comprising:
presenting information of a plurality of key points in a case where the plurality of key points are output by the key point generation model;
receiving information of a selected key point that is the key point selected from the plurality of key points; and
outputting the information of the selected key point.

15. The comprehension support method according to claim 9, wherein
the chart is a line chart indicating schedules of work of a plurality of persons working together, and
the key point is information of work whose influence on a schedule of work of another person among pieces of work of the plurality of persons satisfies a criterion, and information of a person who performs the work.

16. The comprehension support method according to claim 10, wherein
the chart represents contents and schedules of work of a plurality of persons in different roles,
the attribute is information for specifying a target role that is a role of one person among the roles of the plurality of persons, and
the key point is information of the contents and the schedules of the work of the person of the target role.

17. A non-transitory computer readable storage medium storing a program for causing a computer to execute:
input receiving processing of receiving information of a chart that is any of a figure and a table;
key point specifying processing of inputting, into a key point generation model, the received information of a target chart that is the chart, the key point generation model being trained in such a way as to receive information of a chart and output a key point of the chart; and
output processing of outputting information of the key point generated by the key point generation model.

18. The non-transitory computer readable storage medium according to claim 17, wherein
the input receiving processing further receives information of an attribute of a reader of the chart,
the key point generation model is trained in such a way to receive the information of the chart and the information of the attribute of the reader and to output the key point of the chart depending on the attribute, and
the key point specifying processing inputs, to the key point generation model, the information of the target chart and information of a target attribute that is the attribute of the reader.

19. The non-transitory computer readable storage medium according to claim 18, wherein
the key point generation model is trained in such a way to receive the information of the chart, information of a type of the chart, and the information of the attribute and to output the key point of the chart according to the attribute and the type, and
the key point specifying processing inputs, to the key point generation model, the information of the target chart, information of the type of the target chart, and information of a target attribute that is the attribute of the reader.

20. The non-transitory computer readable storage medium according to claim 17, wherein
the program further causes the computer to execute type determination processing of estimating a type of the target chart,
the key point generation model is trained in such a way to receive the information of the chart and information of the type of the chart and to output the key point of the chart depending on the type, and
the key point specifying processing inputs the information of the target chart and information of the type of the target chart to the key point generation model.
